(19) United States
(12) Patent Application Publication
(10) Pub. No.: US 2011/0276268 A1
(43) Pub. Date: Nov. 10, 2011

(54) Apparatus for Determining the Orientation of Vehicles

(76) Inventor: Frederik Meysel, Berlin (DE)

(21) Appl. No.: 12/774,070

(22) Filed: May 5, 2010

(30) Foreign Application Priority Data
May 5, 2010 (DE) 102009019700.1

(51) Int. Cl. G08G 1/16

(52) U.S. Cl. 701/301

(57) ABSTRACT

The invention relates to an apparatus (1) for determining the orientation of vehicles (2) having a plurality of transmitters (31 to 38) which are designed to emit signals and are arranged on a vehicle (2) whose orientation is intended to be determined. In this case, the transmitters (31 to 38) are designed to emit an individual signal pattern, relating to the respective transmitter (31 to 38), within a signal pattern sequence (S), and the apparatus (1) has an orientation determining unit (5), which is intended to be installed in other vehicles (4) and is designed to receive the signal patterns by means of a receiving unit (6). The orientation determining unit (5) is in this case designed to determine the orientation of the vehicle (2) as a function of the signal pattern contained in the signal pattern sequence (S).

The invention relates to an apparatus for determining the orientation of vehicles having a plurality of transmitters which are designed to emit signals and are arranged on a vehicle whose orientation is intended to be determined.

In order to prevent collisions between two vehicles, it is important that, in addition to known technical aids, the vehicle driver as a person is provided with the capability to identify the orientation of another vehicle which is located in his vicinity, in order in this way to allow him to estimate whether his own vehicle is on a collision course with the other vehicle, and/or who has the obligation to turn away. Particularly in the case of vehicles which can be perceived only very vaguely because of their distance, it is often difficult to determine the orientation of the vehicle in space, without further technical aids.

In order to help people determine the orientation of vehicles, vehicles such as aircraft or watercraft have lamps which are fitted on a fuselage or hull and which emit an appropriate red, green or white light signal. Depending on which color signal can be seen, it is then possible to deduce the orientation of the vehicle in space. For example, watercraft have a green light on the starboard (right-hand) side, and a red light on the port (left-hand) side, as a result of which it is possible to use the color which can be seen to identify which side of the watercraft is facing the viewer. In this way, it is possible to deduce the direction of travel.

In the case of aircraft, every aircraft pilot likewise has to actively monitor the air space. Although electronic methods are available for early identification and handling of collision risks, the pilot must still continue to visually monitor the surrounding area. This principle, which is known as “see and avoid” is also currently required for unmanned aircraft, in addition to electronic methods based on satellite navigation and radio communication.

U.S. Pat. No. 3,706,968 discloses a signal light for aircraft which exhibits a different color depending on the orientation angle of the viewer, such that the viewer can tell which side is facing him, by which means it is possible to roughly estimate the direction of flight of the aircraft. Orientation angles of <90° can also be determined by different color codings, on the basis of the circular arrangement of the color filters on the two lamps and an offset arrangement of the color filters.

U.S. Pat. No. 5,337,047 discloses an apparatus for aircraft, by means of which the aircraft type can be determined from long range. For this purpose, the device has a laser apparatus which, depending on the aircraft type (size, number of engines), emits a different number of light signals at different frequencies, thus coding the corresponding characteristics of the aircraft.

The apparatus known from the prior art has the disadvantage that automatic identification of the aircraft orientation is feasible only with difficulty on the basis of the “see and avoid” method, particularly in the case of flying objects a long way away.

The object of the present invention is therefore to specify an improved apparatus for determining the orientation of a vehicle a long distance away.

According to the invention, the object is achieved by the invention of the type mentioned initially in that the transmitters are designed to emit an individual signal pattern, relating to the respective transmitter, within a signal pattern sequence, and the apparatus has an orientation determining unit, which is intended to be installed in other vehicles and is designed to receive the signal patterns by means of a receiving unit, with the orientation determining unit being designed to determine the orientation of the vehicle as a function of the signal patterns contained in the signal pattern sequence.

Therefore, it becomes possible to determine the orientation of a vehicle when the vehicle is a long distance away from the viewer and the light signals emitted by the vehicle can be perceived only as a single light source. For this purpose, transmitters are arranged on the vehicle whose orientation is intended to be determined and emit a signal pattern, which is in each case unique for the transmitter, within a signal pattern sequence. The signal pattern sequence is in this case produced from the set of all the signal patterns which can be emitted by the transmitters, for example by in each case only one transmitter emitting its individual signal pattern at one time, or for example by the transmitters emitting their individual signal pattern partially interleaved/offset.

According to the invention, the apparatus furthermore, has an orientation determining unit which can be installed in other vehicles which wish to determine the orientation of the first vehicle. The orientation determining unit is in this case connected to a receiver, which can receive the signal patterns emitted by the transmitters, and passes them on to the orientation determining unit. The orientation determining unit is in this case designed such that it can evaluate the received signals and can determine which signal pattern has been received within the signal pattern sequence. Because each transmitter emits a unique, individual signal pattern, the orientation determining unit can now determine the orientation of the vehicle, in particular the relative orientation of the vehicle with respect to the viewer. It is thus possible, in the case of aircraft for example, to determine which octant of the vehicle is facing the viewer.

It is thus possible, even in the case of unmanned vehicles, in particular in the case of unmanned aircraft, to use the “see and avoid” principle in the way demanded of human pilots.

The transmitters are in this case advantageously arranged on the vehicle such that at least one signal pattern of one transmitter can be received independently of the angle of the viewer with respect to the vehicle, that is to say at least one signal pattern of a transmitter can always be received, irrespective of the orientation of the vehicle. This makes it possible to ensure that there are no reception gaps at specific viewing angles. In this case, in one exemplary embodiment, at least three signal patterns can always be received from three different transmitters, thus allowing the orientation to be determined considerably more accurately. It is obvious that the accuracy of the orientation determination is proportional to the number of signal patterns which can be received, and vice versa.

It is particularly advantageous for at least one transmitter to be arranged at each end of a spatial axis X, Y and Z. This results in an advantageous arrangement of the transmitters, with a transmission direction to the front and rear, to the left and right, and upward and downward. In this case, it is also possible to receive more than one signal pattern within the signal pattern sequence in certain orientations by means of an appropriate transmission angle of more than 45°, starting from the vertical, of each transmitter, thus allowing the orientation of the vehicle to be determined in considerably more detail. In this case, the accuracy of the orientation determination can be further enhanced by additional transmitters, each having individual signal patterns.

The transmitters are preferably light sources, which are designed to emit light signals or infrared signals. The individual signal patterns of the respective transmitters are then emitted in the form of light patterns, which advantageously have binary coding. The transmitters are therefore individually coded independently of a corresponding wavelength, and therefore not on the basis of a color coding. A binary signal pattern of a transmitter may in this case be the sequence of a pattern sequence of light which is switched on and switched off.

In order to allow the light patters emitted by the optical transmitters to be received, the receiving unit has an optical transmitter which is designed to receive and to record the light signals. A receiving unit such as this may, for example, be a video camera, in particular a digital video camera. If the use of a conventional industrial camera is assumed in this case, with a time resolution of about 50 images per second, then 20 bits per second can reliably be transmitted. In this case, the sampling frequency is more than twice as high as the bit rate, in the form of the light patterns, emitted by the transmitters.

In order to define the precise time sequence of the individual signal patterns within the signal pattern sequence, each transmitter is advantageously assigned a corresponding time slot within the signal pattern sequence, in which the respective transmitter can emit its signal pattern. Only the transmitter which is assigned to this time slot may emit its signal pattern within the time slot. This ensures that no overlaps occur when the signal pattern sequence is being emitted by all the transmitters involved, which signal pattern sequence can then no longer be adequately identified by the orientation determining unit. This therefore clearly defines which transmitter may emit its signal pattern at which time, wherein only one transmitter may in each case transmit its signal pattern at one time.

However, it is also feasible for each signal pattern to be subdivided into individual parts which are then distributed within the signal pattern sequence, with the transmitters not sending their signal patterns in one piece. In a similar manner to the interleaving process, in which the sequence of bits or information items to be transmitted, for example, are interchanged and interleaved with one another, the parts of the individual signal pattern sequence can also be distributed in an interleaved form, as a result of which a signal pattern of one specific transmitter is not emitted in one piece by the corresponding transmitter. For example, one or more other parts from other transmitters, and their corresponding signal pattern parts, may be located between two parts of a signal pattern of one specific transmitter. This interleaving makes it possible to ensure correspondingly greater fail safety on reception. The orientation determining unit can then identify the parts of the received signal patterns as a function of the received patterns, and can correspondingly associate them with the transmitters.

In order to allow the orientation determining unit to identify the start of the signal pattern sequence, the apparatus is preferably designed such that at least one transmitter emits a start sequence signal pattern at the start of the signal pattern sequence. Simultaneous emission of the start sequence signal pattern by all the transmitters ensures that the start sequence can always be received, irrespective of the orientation of the vehicle, thus making it possible to determine the start of the signal pattern sequence. In this case, the orientation determining unit is designed such that it can identify the start sequence signal pattern. The transmitters do not emit their individual signal patterns within the signal pattern sequence until the start sequence signal pattern has been emitted.

Furthermore, it is particularly advantageous if, in addition to the signal patterns for orientation determination, the transmitters also emit signal patterns by means of which specific information relating to the vehicle can be emitted. Such information may, for example, be the transponder code, the direction of travel, the speed, the altitude and the rate of climb/descent of the vehicle. These information signal patterns are preferably emitted by each transmitter at the end of the signal pattern sequence, such that in this case as well, the information signal patterns can be received once again independently of the orientation of the vehicle. In this case, the orientation determining unit is designed such that it extracts the appropriate information from the received signal patterns in the signal pattern sequence.

In order enhance the transmission reliability, it is particularly advantageous for appropriate check, parity and/or correction information to be sent in addition to the signal patterns, with the aid of which the orientation determining unit can then check the integrity of the received signal patterns. For example, it is thus possible to tell whether specific signal patterns have not been received completely by the receiving unit, because of weather conditions. Relatively small bit errors can then also be corrected with the aid of appropriate correction information within the signal pattern sequence.

Furthermore, it is particularly advantageous for the apparatus to be designed to automatically determine a turning-away obligation or risk of collision as a function of the orientation of the vehicle determined by the orientation determining unit. In vehicles in which the orientation determining unit is installed, it is then possible to use the apparatus according to the invention to determine the magnitude of a collision risk with the vehicle a long distance away whose orientation is intended to be determined, and a suitable turning-away maneuver can be selected and initiated if necessary. Such collision identification can then further assist the “see and avoid” principle.

In the case of manned aircraft, it is particularly advantageous for the orientation determining unit to be connected to a display apparatus, on which the spatial orientation of the vehicle as determined by the orientation determining unit can be displayed. The spatial orientation of the vehicle can then be displayed intuitively to the appropriate vehicle driver or pilot, even when the vehicle is a long distance away, and purely visual identification of the spatial orientation is no longer possible.

The invention will be explained in more detail with reference, by way of example, to the attached drawings, in which:

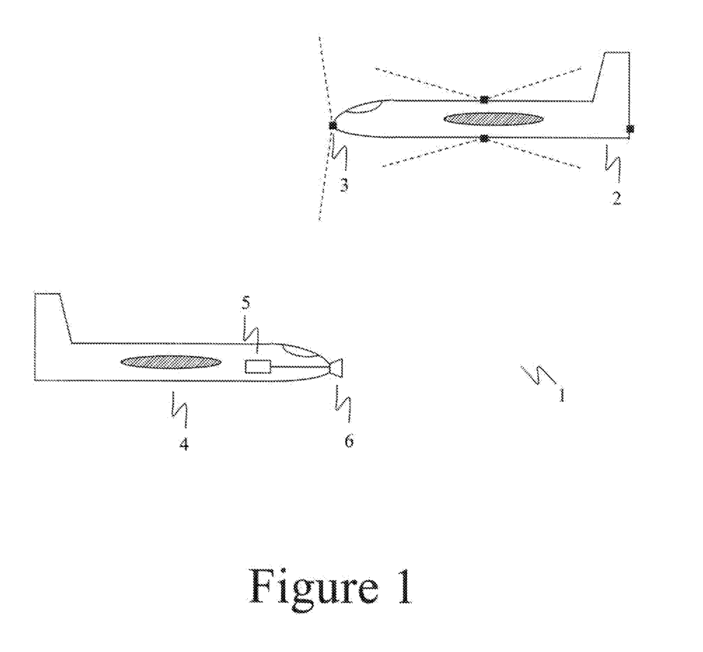

FIG. 1—shows a schematic illustration of the apparatus;

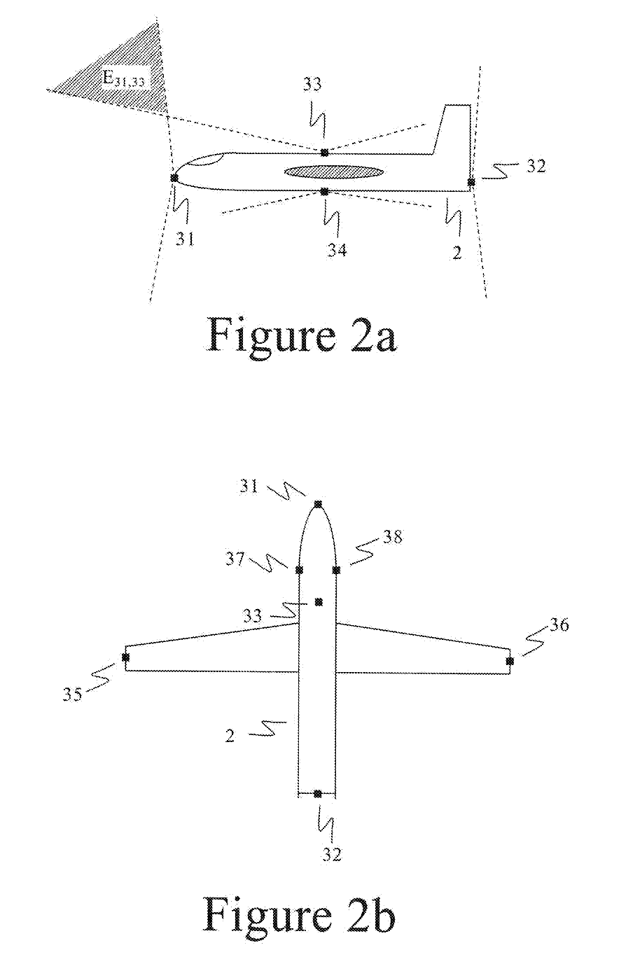

FIGS. 2a, 2b—show schematic illustrations of the transmitter arrangement on an aircraft;

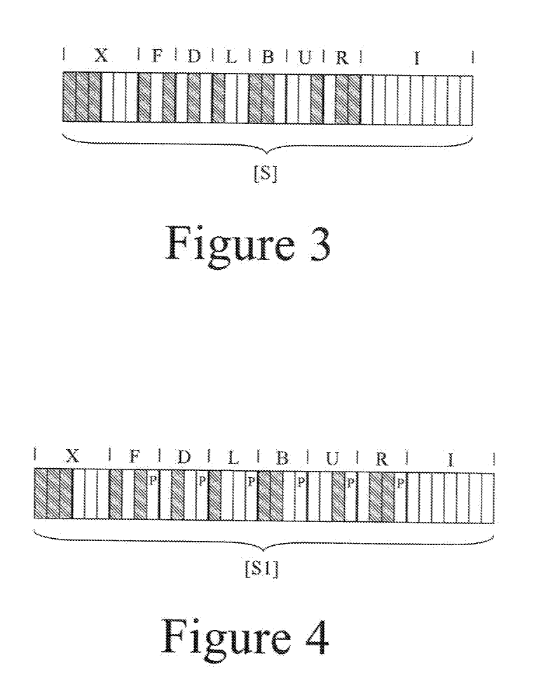

FIG. 3—shows an exemplary embodiment of a signal pattern code;

FIG. 4—shows an exemplary embodiment of a signal pattern code with parity bits;

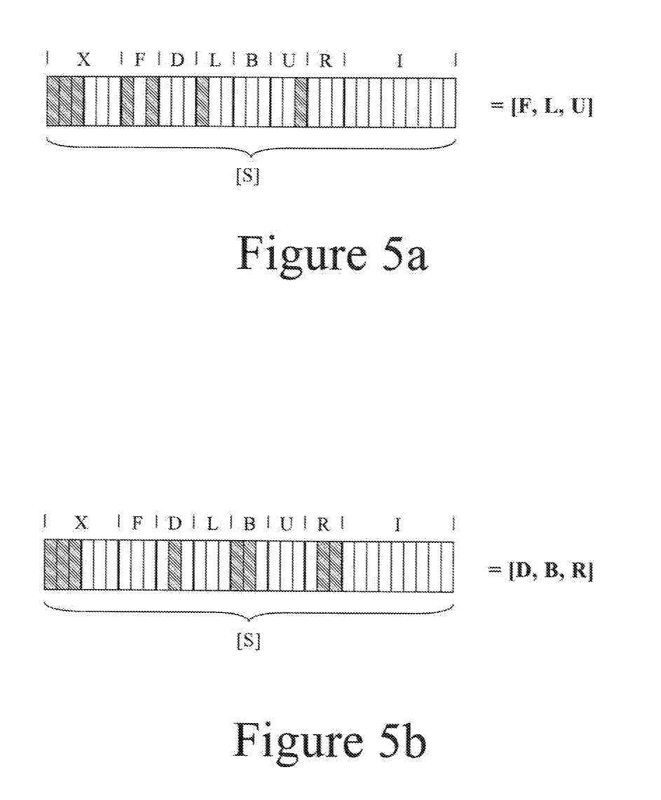

FIGS. 5a, 5b—show an exemplary embodiment of a received signal pattern sequence;

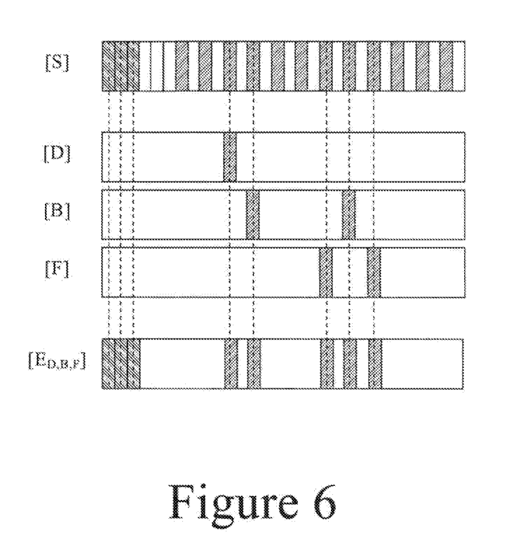

FIG. 6—shows an exemplary embodiment of an interleaving signal pattern sequence.

FIG. 1 shows, schematically, the apparatus 1 according to the present invention. A plurality of transmitters 3, which emit a signal pattern which is specific for the respective transmitter 3, are arranged on an aircraft 2, whose orientation in space is intended to be determined with the aid of the apparatus 1. In this exemplary embodiment, the transmitters 3 are designed such that they emit an appropriate light pattern, which is not color-coded, corresponding to their arrangement on the fuselage.

An orientation determining unit 5, which is connected to an appropriate receiver 6, is installed in a further aircraft 4 which is intended to determine the orientation of the aircraft 2. In this exemplary embodiment, the receiver 6 is designed to receive the light patterns emitted by the transmitters 3. In this case, a receiver 6 such as this may be, for example, a video camera with a normal time resolution of about 50 images per second.

The optical receiver 6 in the apparatus 1 now receives the light patterns emitted by the transmitters 3 and passes them to the orientation determining unit 5, which then determines the relative orientation of the aircraft 2 as a function of the received light patterns within the signal pattern sequence.

FIGS. 2a and 2b also once again schematically show a preferred method of arrangement of the transmitters 3, with one such transmitter being arranged at least each end of a spatial axis. FIG. 2a shows a side view of the aircraft 2. A transmitter 31, which emits its light pattern in the direction of flight, is arranged on the nose of the aircraft 2. The transmitter 32, which emits its light pattern in the opposite direction to the direction of flight, is located on the tail of the aircraft. A corresponding light pattern is emitted upward with the aid of the transmitter 33, and a corresponding light pattern is emitted downward by the transmitter 34. All the transmitters transmit with a beam angle of at least 160°.

As a result of the broad beam angle of the transmitters, the receivable signal patterns intersect in specific areas (E_{31,33}), such that both the signal pattern from the transmitter 31 and the signal pattern from the transmitter 33 can be received at this point. The orientation of the aircraft can therefore be determined considerably more accurately. It is even possible to receive three or more signal patterns at the same time in the air space in this case.

FIG. 2b shows a plan view of the aircraft 2 whose orientation in space is intended to be determined. In this case, a further transmitter 35 is arranged on the port wing, and emits an appropriate light pattern to port. The transmitter 36 is arranged on the starboard wing, and likewise emits an appropriate light pattern to starboard.

In order to increase the accuracy of the orientation determination of the aircraft 2, in each case two transmitters 37 and 38, which likewise emit an appropriately coded light signal, are located in this exemplary embodiment in the front area of the aircraft at the port and starboard sides. The emission angle of the two transmitters 37 and 38 is in this case chosen such that it intersects the emission angle of the front transmitter 31 and the side transmitters 35 and 36 in a specific area. If a corresponding light pattern of the transmitter 37 or 38 is received then it is always possible to receive either the light pattern emitted forward by the transmitter 31 or one of the light patterns from the side transmitters 35 or 36, thus allowing the orientation of the aircraft 2 to be determined considerably more accurately.

By way of example, FIG. 3 schematically illustrates a signal pattern sequence S, as is emitted by an arrangement of the transmitters in FIG. 2a or FIG. 2b. The individual signal patterns are in this case binary-coded light patterns, with one bit being represented by the states light on (1) or light off (0).

All the transmitters first of all simultaneously emit a start sequence X at the start of the signal pattern sequence S, as a result of which the orientation determining unit 5 can determine the start of the signal pattern sequence S. In this case, the start sequence X comprises a 6-bit code, with the first three bits being in the state 1 (light on) and the last three bits being in the state 0 (light off).

Following this, the first individual light pattern F is emitted exclusively by the transmitter 31 pointing forward, and in this exemplary embodiment this light pattern F has the binary code 101. If the light pattern F was emitted by the transmitter 31, then, in this exemplary embodiment, the transmitter 34 pointing downward would be the next to emit its corresponding signal pattern D, which in this example has a binary code 010. After this, the port transmitter 35 transmits its signal pattern L (binary 100), followed by the transmitter 32 pointing to the rear with the signal pattern B (binary 110). Toward the end of the signal pattern sequence S, the transmitter 33 aligned upward then emits its signal pattern U with binary 001, and, finally, the starboard transmitter 36 emits its signal pattern R (binary 011).

Once all the transmitters have successively emitted their corresponding signal pattern from the signal pattern sequence S, the signal pattern sequence once again starts with the start sequence X, possibly with a short pause in between.

However, the last individual signal pattern R from the transmitter 36 can advantageously also be followed by further light patterns, which are emitted simultaneously by all the transmitters and contain appropriate information I relating to the aircraft 2, in binary-coded form. Inter alia, this therefore allows the transponder code, the direction of flight, the speed and the rate of climb and descent of the aircraft 2 to be transmitted at the end of the signal pattern sequence S.

Based on the signal pattern sequence S from FIG. 3, FIG. 4 shows a signal pattern sequence S1 which, in addition to the individual light patterns described in FIG. 3, has a parity bit P for each light pattern. In this case, by way of example, each light pattern from the transmitters 31 to 38, which are binary-coded by three bits, has a further parity bit added to it, as a result of which each individual light pattern is now represented by four bits. In the simplest form, a parity bit P such as this indicates how many even or odd bits there are in the corresponding message, thus allowing integrity monitoring to be carried out by the orientation determining unit 5 with as little complexity as possible. This integrity monitoring is particularly advantageous in order to allow transmission errors or brief concealments or other disturbance influences to be identified in good time, thus preventing incorrect calculations of the orientation.

The individual high levels of an individual signal light can in this case be distributed in the code such that, for example, sufficient time is available for charging an energy store for a flash discharge. If this time is not sufficient to transmit an aircraft attitude at, for example, 0.5 Hz (every two seconds), a plurality of light sources can be accommodated in in each case one coded light.

Lower power levels can be used to transmit the additional information I.

A pause of one second, for example, may be included between two respective signal pattern sequences.

The code described by way of example here includes sufficient redundancy to identify single transmission errors. However, it is also possible to use codes which cannot only identify but also correct any transmission error of individual bits.

By way of example, FIGS. 5a and 5b show a received signal code.

In this case, in addition to the start sequence X, the signal patterns F, L and U are received in FIG. 5a, with the signal pattern F being emitted by the transmitter 31, the signal pattern U by the transmitter 33 and the signal pattern L by the transmitter 35. The other signal patterns within the signal pattern sequence S cannot be received in this case, as a result of which a binary 000 is determined by the orientation determining unit in these areas.

The received signal patterns can now be used to determine which transmitters are facing the viewer, in this case the aircraft 4, as a result of which the orientation of the aircraft 2 in space can finally then be deduced.

FIG. 5b shows a code sequence in which the signal patterns D, B and R have been received. In this case, each signal pattern or light pattern has its own position within the signal pattern sequence, which is emitted sequentially, distributed in time, via all the transmitters.

FIG. 6 show another exemplary embodiment of how the signal pattern frequency S can be formed. In this case, the individual parts of an individual signal pattern of one transmitter are distributed over the signal pattern sequence, in which case, in this case as well, only in each case one part of a signal pattern may occur at one point within the signal pattern sequence. As an example, the signal pattern sequence S is shown at the top in FIG. 6, as could be received if all the signal patterns from the transmitters could be received.

However, only the transmitters D, B and F can be received in the exemplary embodiment in FIG. 6, as is shown under the signal pattern sequence S. In this case, the individual parts of a signal pattern from a corresponding transmitter are distributed over the entire signal pattern sequence, as a result of which a complete signal pattern from one transmitter is not emitted in its entire sequence, in a similar manner to that in the case of interleaving methods. Other parts from other transmitters and signal patterns may also be located between the individual parts, which are shown in a shaded form here, and can then be received as shown in the lower part of FIG. 6. A total of five parts are received there (E_{D,B,F}), as a result of which, for example, it is possible by means of a simple AND logic operation with the stored signal patterns from the individual transmitters to find which signal patterns of which transmitters have been received.

In this embodiment as well, it is, of course, self-evidently feasible for the transmitters to emit a standard start pattern at the start of each signal pattern sequence, and if required also to transmit information at the end of the signal pattern sequence. In this exemplary embodiment, the coding is furthermore also carried out on the basis of the time at which the parts of the signal patterns are emitted within the signal pattern sequence.

1. An apparatus for determining the orientation of vehicles having a plurality of transmitters which are designed to emit signals and are arranged on a vehicle whose orientation is intended to be determined, wherein the transmitters are designed to emit an individual signal pattern, relating to the respective transmitter, within a signal pattern sequence, and the apparatus has an orientation determining unit, which is intended to be installed in other vehicles and is designed to receive the signal patterns by means of a receiving unit, with the orientation determining unit being designed to determine the orientation of the vehicle as a function of the signal patterns contained in the signal pattern sequence.

2. The apparatus as claimed in claim 1, wherein the transmitters are arranged on the vehicle such that at least one signal pattern within the signal pattern sequence can be received independently of the orientation of the vehicle in space.

3. The apparatus as claimed in claim 1, wherein the transmitters are designed to emit the signal patterns by means of electromagnetic signals, in particular light signals or infrared signals.

4. The apparatus as claimed in claim 3, wherein the transmitters are designed to emit a light pattern as a signal pattern, in particular a binary light pattern.

5. The apparatus as claimed in claim 4, wherein the transmitters are designed to emit a binary light pattern such that each binary light pattern has an individual binary coding relating to the respective transmitter.

6. The apparatus as claimed in one of claim 3, wherein the receiving unit is an optical sensor, in particular a video camera for receiving optical signals.

7. The apparatus as claimed in claim 1, wherein at least one transmitter is arranged at each end of a spatial axis of the vehicle.

8. The apparatus as claimed in claim 1, wherein the transmitters are designed to emit the signal patterns at an angle of at least 45° from the vertical.

9. The apparatus as claimed in claim 1, wherein each transmitter is designed to emit the respective signal pattern in a time slot, which is assigned to the respective transmitter, within the signal pattern sequence.

10. The apparatus as claimed in claim 1, wherein each transmitter is designed to emit the respective signal pattern such that parts of the respective signal pattern are interleaved with one another within the signal pattern sequence.

11. The apparatus as claimed in claim 1, wherein the transmitters are designed to emit a start sequence signal pattern at the start of the signal pattern sequence, and the orientation determining unit is designed to identify the start sequence signal pattern as the start of the signal pattern sequence.

12. The apparatus as claimed in claim 1, wherein at least one of the transmitters is designed to emit an information signal pattern, which contains information relating to the vehicle, within the signal pattern sequence, and the orientation determining unit is designed to extract the information from the received information signal pattern.

13. The apparatus as claimed in claim 12, wherein the information signal pattern contains information relating to the transponder code, the direction of travel, the speed, the altitude and/or the rate of climb/descent of the vehicle.

14. The apparatus as claimed in claim 1, wherein the transmitters are designed to emit test, parity and/or correction information within the signal patterns, and the orientation determining unit is designed to monitor the integrity of the received signal patterns as a function of the test, parity and/or correction information.

15. The apparatus as claimed in claim 1, wherein the apparatus is designed to determine a risk of collision as a function of the determined orientation of the vehicle.

16. The apparatus as claimed in claim 1, wherein the orientation determining unit is connected to a display apparatus for displaying the orientation of the vehicle, in particular the relative orientation with respect to the other vehicle.

17. An orientation determining unit for determining the orientation of a vehicle as claimed in claim 1, having a receiving unit for receiving the signal patterns which are contained in the signal pattern sequence.
